(19) United States
(12) Patent Application Publication
(10) Pub. No.: US 2016/0078777 A1
(43) Pub. Date: Mar. 17, 2016

(54) ELECTRONIC APPARATUS AND SOFT LOCKING METHOD THEREOF

(71) Applicant: National Tsing Hua University, Hsinchu City (TW)

(72) Inventors: Shan-Hung Wu, Hsinchu (TW); Shao-Kan Pi, Taichung City (TW); Ting-Yu Cheng, Taichung City (TW)

(21) Appl. No.: 14/576,171

(22) Filed: Dec. 18, 2014

(30) Foreign Application Priority Data
Sep. 17, 2014 (TW) 103132043

(51) Int. Cl. G09B 19/00

(52) U.S. Cl. CPC G09B 19/00

(57) ABSTRACT

An electronic apparatus and a soft locking method thereof are provided. The method is adapted for at least one electronic apparatus. In the method, the at least one electronic apparatus is added to a group and an event is created for the at least one electronic apparatus to participate in. Next, a specific operation performed on each electronic apparatus is detected and a time that all of the at least one electronic apparatus does not detect the specific operation is accumulated. When any one of the at least one electronic apparatus detects the specific operation, the event is suspended and a suspension message is distributed. When the accumulated time reaches a predetermined value, a reward is sent to the at least one electronic apparatus participating in the event.

### CROSS-REFERENCE TO RELATED APPLICATION

This application claims the priority benefit of Taiwan application serial no. 103132043, filed on Sep. 17, 2014. The entirety of the above-mentioned patent application is hereby incorporated by reference herein and made a part of this specification.

### BACKGROUND

1. Technical Field

The invention relates to an electronic apparatus and a locking method thereof, and particularly relates to a method and an apparatus capable of soft locking an electronic apparatus via a peer pressure.

2. Related Art

In recent years, since electronic apparatuses, such as smart phones, or table personal computers (PCs), have developed diversified functions, a usage frequency of the electronic apparatuses is greatly increased, and people's attention always stays on the electronic apparatuses, such that the press names such people as a “heads-down tribe”. The electronic apparatuses are convenient, but in some specific occasions, such as class, work, meetings, or gatherings, using the electronic apparatuses may influence users themselves and others, and it is necessary to temporarily prevent people from using the electronic apparatuses.

Generally speaking, a hard locking mechanism can be used to force the user not to use the electronic apparatus. However, since such direct forcing method violates a use right of the user, it is usually not accepted by the user, and the user is easy to skip the hard locking mechanism by rebooting the electronic apparatus. Therefore, it is necessary to provide a mechanism to resolve the above problem.

### SUMMARY

The invention is directed to an electronic apparatus and a soft locking method thereof, which softly dissuade a user from using the electronic apparatus based on the sense of accomplishment and pride of human nature.

The invention provides a soft locking method for electronic apparatus, which is adapted for at least one electronic apparatus. In the method, the at least one electronic apparatus is added to a group, and an event is created for the at least one electronic apparatus to participate in. Next, a specific operation performed on each of the at least one electronic apparatus is detected and a time that all of the at least one electronic apparatus does not detect the specific operation is accumulated. When any one of the at least one electronic apparatus detects the specific operation, the event is suspended and a suspension message is distributed. When the accumulated time reaches a predetermined value, a reward is sent to the at least one electronic apparatus participating in the event.

In an embodiment of the invention, the step of adding the at least one electronic apparatus to the group for participating in the event includes following steps. One of the at least one electronic apparatus launches the group, and invites other electronic apparatuses in the at least one electronic apparatus to join the group. A confirmation message sent by each of the electronic apparatuses in response to the invitation is received, so as to activate the event for the at least one electronic apparatus to participate in.

In an embodiment of the invention, the specific operation detected by each of the at least one electronic apparatus includes a press operation performed on a physical key, a touch operation performed on a touch screen, an unlocking operation performed under a screen locking state or a trigger operation for a specific application.

In an embodiment of the invention, the step of distributing the suspension message includes distributing the suspension message to all of the at least one electronic apparatus in the group or a social networking website joined by each of the at least one electronic apparatus.

In an embodiment of the invention, after the step of distributing the suspension message or sending the reward to the at least one electronic apparatus participating in the event, the soft locking method further records the suspension message and the reward for each of the at least one electronic apparatus to inquire.

The invention provides an electronic apparatus including a communication unit, a storage unit and a processing unit. The communication unit is configured to establish connections with a plurality of electronic apparatuses. The storage unit is configured to record a plurality of modules. The processing unit is configured to access and execute the modules recorded by the storage unit. The modules include an event creating module, a detection module, a timing module, a message distributing module and a reward generating module. The event creating module respectively adds the electronic apparatuses to a group, and creates an event for the electronic apparatuses to participate in. The detection module detects a specific operation performed on each of the electronic apparatuses. The timing module accumulates a time that all of the electronic apparatuses do not detect the specific operation. The message distributing module suspends the event and distributes a suspension message when the detection module detects the specific operation on any of the electronic apparatuses. The reward generating module sends a reward to the electronic apparatuses participating in the event when the time accumulated by the timing module reaches a predetermined value.

In an embodiment of the invention, the event creating module launches the group, invites the other electronic apparatuses to join the group, receives a confirmation message sent by each of the electronic apparatuses in response to the invitation, and accordingly activates the event for the electronic apparatuses to participate in.

In an embodiment of the invention, the specific operation detected by the detection module includes a press operation performed on a physical key, a touch operation performed on a touch screen, an unlocking operation performed under a screen locking state or a trigger operation for a specific application.

In an embodiment of the invention, the message distributing module distributes the suspension message to all of the electronic apparatuses in the group or a social networking website joined by each of electronic apparatuses.

In an embodiment of the invention, the modules further include a recording module for recording the suspension message and the reward for each of the electronic apparatuses to inquire.

According to the above descriptions, in the electronic apparatus and the soft locking method thereof of the invention, by inviting one or a plurality of users to commonly participate in an event, the users are dissuaded from using the electronic apparatuses within a specific time length. If the goal is achieved, a reward is sent to each of the users participating in the event; and if someone breaks the rule, not only the event is suspended, user formation of the user that causes the suspension is distributed to each of the participators, or distributed to the social networking website commonly joined by the users. By using a virtual or real reward or punishment and a social pressure, the user can be dissuaded from using the electronic apparatus.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic apparatus according to an embodiment of the invention.

FIG. 2 is flowchart illustrating a soft locking method for electronic apparatus according to an embodiment of the invention.

FIG. 3 is a flowchart illustrating a soft locking method for electronic apparatus according to an embodiment of the invention.

FIG. 4A to FIG. 4D illustrate an example of a soft locking method for electronic apparatus according to an embodiment of the invention.

### DETAILED DESCRIPTION OF DISCLOSED EMBODIMENTS

The invention introduces a concept of a soft locking mechanism, which is different to the ordinary hard locking mechanism that directly forces a user not to use an electronic apparatus. Based on the sense of accomplishment and pride of human nature, and in collaboration with a virtual or real reward or punishment and a peer pressure, the user is softly dissuaded from using the electronic apparatus. After the user activates the locking function of the invention, the electronic apparatus supervises whether the user uses the electronic apparatus within a specific time length. If the user does not use the electronic apparatus, the user may get a virtual reward or accomplishment, and if the user uses the electronic apparatus, the user may have a virtual loss or punishment. Moreover, a plurality of users can simultaneously use such software, and the users can supervise each other and check a reward or punishment status of each other, so as to achieve a purpose of dissuading the users from using the electronic apparatuses through virtual or real reward or punishment and the peer pressure. In this way, the user feels himself has the right to choose, which avails developing user's self-control and reducing user's dislike to the software.

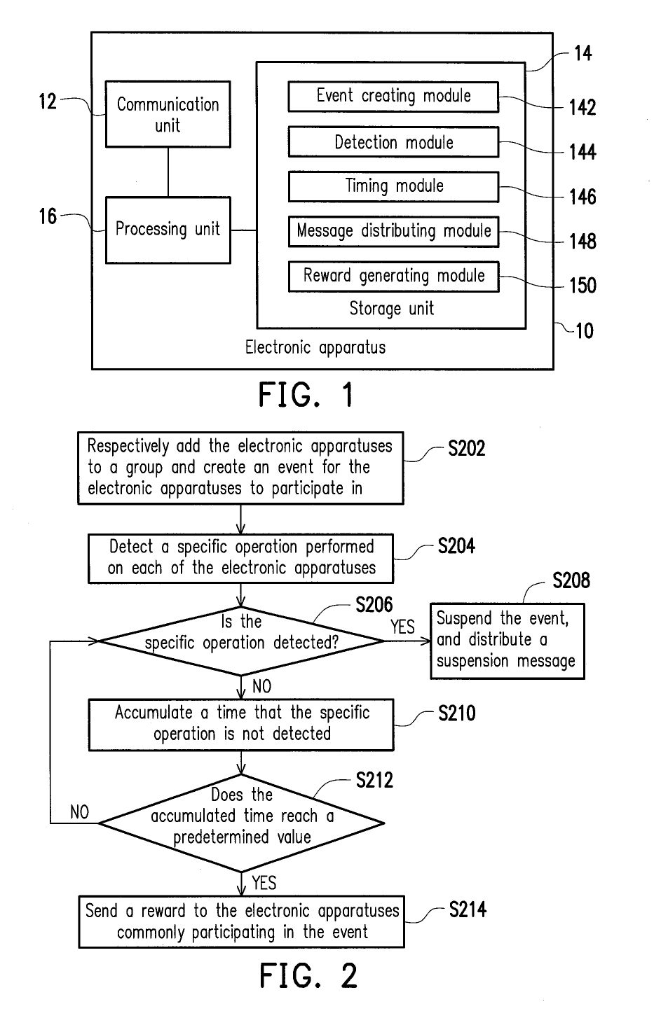

FIG. 1 is a block diagram of an electronic apparatus according to an embodiment of the invention. Referring to FIG. 1, the electronic apparatus 10 of the present embodiment includes a communication unit 12, a storage unit 14 and a processing unit 16. The electronic apparatus 10 is, for example, a mobile phone, a tablet personal computer (PC), or a notebook computer, which is not limited by the invention.

The communication unit 12 can support at least one of the following wireless signal transmission techniques: global system for mobile communication (GSM), personal handy-phone system (PHS), code division multiple access (CDMA), wireless fidelity (Wi-Fi), Wi-Fi direct, worldwide interoperability for microwave access (WiMAX), bluetooth, radio repeater or radio broadcaster, though the invention is not limited thereto. In the present embodiment, the communication unit 12 is used for communicating with other electronic apparatuses.

The storage unit 14 can be any type of a fixed or movable random access memory (RAM), read-only memory (ROM), flash memory or similar devices or a combination of the above devices. In the present embodiment, the storage unit 14 is used for recording an event creating module 142, a detection module 144, a timing module 146, a message distributing module 148 and a reward generating module 150. These modules are, for example, programs stored in the storage unit 14, which can be loaded to the processing unit 16 of the electronic apparatus 10 for executing the soft locking function.

The processing unit 16 is respectively connected to the communication unit 12 and the storage unit 14, which can be a central processing unit (CPU), or other programmable general purpose or specific purpose microprocessor, a digital signal processor (DSP), a programmable controller, an application specific integrated circuit (ASIC) or other similar devices or a combination of the above devices. In the present embodiment, the processing unit 16 is used for accessing and executing the modules recorded in the storage unit 14 to implement the soft locking method of the invention.

In detail, FIG. 2 is flowchart illustrating a soft locking method for electronic apparatus according to an embodiment of the invention. Referring to FIG. 1 and FIG. 2, the method of the present embodiment is adapted for the aforementioned electronic apparatus 10. A detailed flow of the method of the present embodiment is described below with reference to various components of the electronic apparatus 10 of FIG. 1.

First, the event creating module 142 respectively adds external electronic apparatuses connected to the electronic apparatus 10 to a group for commonly participating in an event (step S202). In an embodiment, the event creating module 142, for example, launches the group according to user's requirement, and invites the other electronic apparatuses to join the group according to user's selection, and then receives a confirmation message sent by each of the electronic apparatuses in response to the invitation, so as to activate the event for the electronic apparatuses to commonly participate in. The event creating module 142, for example, selects at least one contact from a plurality of contacts in an address book, a social networking website or instant communication software to establish the group, or directly selects a pre-established group in the address book, the social networking website or the instant communication software to send the invitation, which is not limited by the invention. It should be noticed that the aforementioned event is, for example, to commonly play a game, or commonly execute a task that is suitable for being participated by a plurality of users and suitable for cohering a centripetal force of people on all of the electronic apparatuses, which is not limited by the invention.

It should be noticed that in another embodiment, the electronic apparatuses within a same region can actively join an ongoing event, or a server can pair the electronic apparatuses executing the same event at the same time, so as to facilitate the electronic apparatuses commonly participating in the event. In brief, an event launching method is not limited by the invention, and any method suitable for a plurality of users (i.e. a plurality of the electronic apparatuses) to simultaneously participate in is considered to be within the scope of the invention.

Then, the detection module 144 detects a specific operation performed on each of the electronic apparatuses (including the electronic apparatus 10) (step S204), and determines whether any electronic apparatus detects the specific operation (step S206). The specific operation is, for example, a press operation performed on a physical key (including function keys such as a power key, a volume key, or a home key) of any electronic apparatus, a touch operation performed on a touch screen, an unlocking operation performed under a screen locking state of the electronic apparatus or a trigger operation for a specific application, and the specific operation can also be other operations that cause distraction of the user or influence the others, which is not limited by the invention. When any of the electronic apparatuses in the group detects such specific operation, the electronic apparatus, for example, sends a notification to the electronic apparatus 10, and accordingly the detection module 144 determines an operation status of each of the electronic apparatuses.

When the detection module 144 detects the specific operation on any of the electronic apparatuses, the message distributing module 148 suspends the event and distributes a suspension message (step S208). The message distributing module 148, for example, suspends the game, task or other events performed on each of the electronic apparatuses, and metes out punishment. Meanwhile, in an embodiment, the message distributing module 148 distributes the suspension message to all of the electronic apparatuses in the group, such that the user of each electronic apparatus learns that the event is suspended and learns a name of the user that causes the suspension of the event. In another embodiment, the message distributing module 148 distributes the suspension message to the social networking website joined by each of the electronic apparatuses, such that social networking friends of the user of each electronic apparatus learns the suspension of the event and learns the name of the user that causes the suspension of the event.

In step S206, if the detection module 144 does not detect the specific operation on the electronic apparatuses, the timing module 146 accumulates a time that all of the electronic apparatuses do not detect the specific operation (step S210), and determines whether the accumulated time reaches a predetermined value (step S212). The predetermined value is, for example, determined by the user that launches the group according to a present schedule (for example, class, work, meeting, or gathering), or determined by the users joining the group through voting, and a time length thereof is, for example, 5 minutes, 10 minutes or one hour, which is not limited by the invention.

If the timing module 146 determines that the accumulated time does not reach the predetermined value, the flow returns to the step S206, and the detection module 144 continues to determine whether the specific operation is detected. Conversely, if the timing module 146 determines that the accumulated time reaches the predetermined value, the reward generating module 150 sends a reward to the electronic apparatuses commonly participating in the event. The reward is, for example, a reward of the game, the task, or a coupon, a prize or other real reward given through cooperation with other companies, which is not limited by the invention. Certainly, similar to the mode of event suspension, the electronic apparatus 10 can also control the message distributing module 148 to distribute a completion message to all of the electronic apparatuses in the group or to the social networking website joined by each of the electronic apparatuses, such that the user of each electronic apparatus or the social networking friends thereof can learn that the event is accomplished.

It should be noticed that in an embodiment, the modules stored in the storage unit 14 further include a recording module (not shown), which records the distributed suspension message and the sent reward after the message distributing module 148 distributes the suspension message or the reward generating module 150 sends the reward, so as to facilitate each of the at least one electronic apparatus inquiring the suspension message and the reward later. In this way, the user of the electronic apparatuses can keep tracking the participated events and results thereof, which helps the users to develop their self-control.

By using the aforementioned virtual or real reward or punishment mechanism and social networking share mechanism, and based on the sense of accomplishment and pride of human nature, a user can be softly dissuaded from using the electronic apparatus within a limited time period, such that the user can focus on the currently ongoing event or task. Besides the aforementioned multi-user participating mode, the invention can also be applied to a single user, such that the user of each electronic apparatus can constrain himself not to use the electronic apparatus. Another embodiment is provided below for illustration.

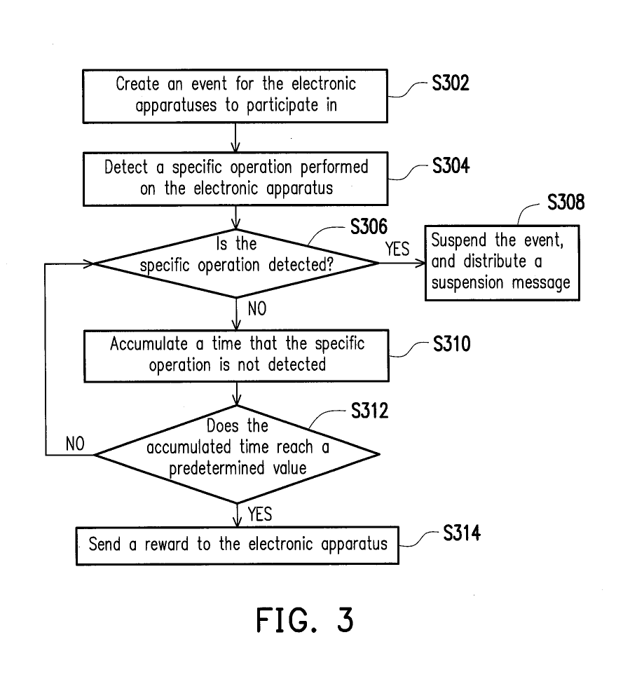

In detail, FIG. 3 is a flowchart illustrating a soft locking method for electronic apparatus according to an embodiment of the invention. Referring to FIG. 1 and FIG. 3, the method of the present embodiment is adapted for the aforementioned electronic apparatus 10. A detailed flow of the method of the present embodiment is described below with reference to various components of the electronic apparatus 10 of FIG. 1.

First, the event creating module 142 creates an event for the electronic apparatus 10 to participate in (step S302). The event is, for example, to play a game or execute a task on the electronic apparatus 10, which is not limited by the invention.

Then, the detection module 144 detects a specific operation performed on the electronic apparatus 10 (step S304), and determines whether the specific operation is detected (step S306). The specific operation is, for example, a press operation performed on a physical key (including function keys such as a power key, a volume key, or a home key) of the electronic apparatus 10 by the user, a touch operation performed on a touch screen, an unlocking operation performed under a screen locking state of the electronic apparatus 10 or a trigger operation for a specific application, and the specific operation can also be other operations that cause distraction of the user or influence the others, which is not limited by the invention.

When the detection module 144 detects the specific operation on the electronic apparatus 10, the message distributing module 148 suspends the event and distributes a suspension message (step S308). The message distributing module 148, for example, suspends the game, task or other events performed on the electronic apparatus 10, and metes out other punishment. Meanwhile, in an embodiment, the message distributing module 148 displays the suspension message on the electronic apparatus 10 to notify the user of the electronic apparatus 10, or distributes the suspension message to the social networking website joined by the user of the electronic apparatus 10, such that social networking friends of the user of the electronic apparatus 10 learn that the event is suspended.

In step S306, if the detection module 144 does not detect the specific operation on the electronic apparatus 10, the timing module 146 accumulates a time that the electronic apparatus 10 does not detect the specific operation (step S310), and determines whether the accumulated time reaches a predetermined value (step S312). The predetermined value is, for example, determined by the user according to a present schedule (for example, class, work, meeting, or gathering), and a time length thereof is, for example, 5 minutes, 10 minutes or one hour, which is not limited by the invention.

If the timing module 146 determines that the accumulated time does not reach the predetermined value, the flow returns to the step S306, and the detection module 144 continues to determine whether the specific operation is detected. Conversely, if the timing module 146 determines that the accumulated time reaches the predetermined value, the reward generating module 150 sends a reward to the electronic apparatus 10. The reward is, for example, a reward of the game or the task. Similarly, according to the mode of event suspension, the electronic apparatus 10 can also control the message distributing module 148 to distribute a completion message to the social networking website joined by the user of the electronic apparatus 10, such that the social networking friends of the user learn that the event is accomplished.

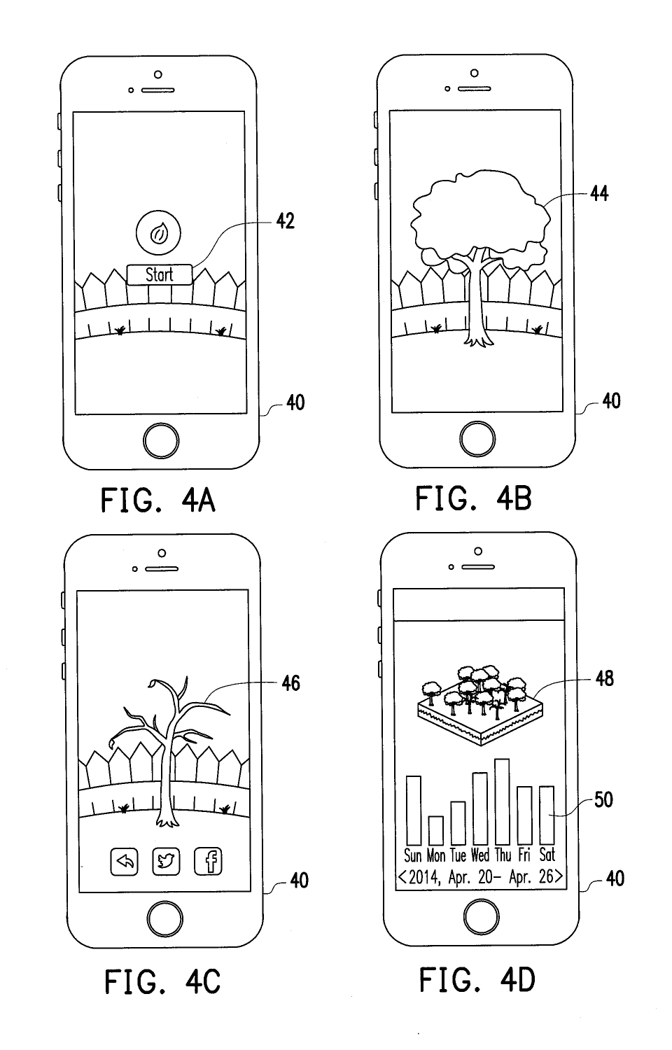

For example, FIG. 4A to FIG. 4D illustrate an example of a soft locking method for electronic apparatus according to an embodiment of the invention. When a user of the electronic apparatus 40 creates an event by himself or invites other electronic apparatuses to commonly participate in the event, the electronic apparatus 40 displays a start key 42 on the screen thereof, as shown in FIG. 4A. When the user presses the start key 42, the electronic apparatus 40, for example, cultivates a tree 44 on the screen (meanwhile, the other electronic apparatuses also cultivate a tree on the screen), as shown in FIG. 4B. Now, the electronic apparatus 40 keeps detecting a specific operation performed on each of the electronic apparatuses, and if the electronic apparatus 40 does not detect the specific operation, the cultivated tree 44 keeps growing. Conversely, if the electronic apparatus 40 detects the specific operation on the electronic apparatus within a predetermined time period, the cultivated tree 46 is withered, as shown in FIG. 4C, and the electronic apparatus 40 can distribute the suspension message to the other connected electronic apparatuses or a social networking website such as Twitter, Facebook, etc. Moreover, the electronic apparatus 40 further records an execution result of the event everyday, and presents the execution results through a figure. For example, the execution results from Sunday to Saturday are illustrated in FIG. 4D, and a forest 48 is drawn according to the execution results of all of the events from Sunday to Saturday. In this way, the user of the electronic apparatus 10 (and the other electronic apparatuses) can be softly dissuaded from using the electronic apparatus, and the user can keep tracking the participated events and the execution results thereof, which helps the user to develop his self-control.

In summary, in the electronic apparatus and the soft locking method thereof of the invention, a single user creates an event alone or a plurality of users commonly participate in the event, and it is detected whether an electronic apparatus is used within a time period, so as to provide a virtual reward or punishment for reminding the user. Moreover, based on mutual supervision of a plurality of users, and inquiry of mutual reward or punishment status, a purpose of dissuading the user from using the electronic apparatus via peer pressure is achieved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A soft locking method for electronic apparatus, adapted for at least one electronic apparatus, comprising:
adding the at least one electronic apparatus to a group, and creating an event for the at least one electronic apparatus to participate in;
detecting a specific operation performed on each of the at least one electronic apparatus, and accumulating a time that all of the at least one electronic apparatus does not detect the specific operation;
suspending the event and distributing a suspension message when any one of the at least one electronic apparatus detects the specific operation; and
sending a reward to the at least one electronic apparatus participating in the event when the accumulated time reaches a predetermined value.

2. The soft locking method for electronic apparatus as claimed in claim 1, wherein the step of adding the at least one electronic apparatus to the group for participating in the event comprises:
launching the group by one of the at least one electronic apparatus, and inviting the other electronic apparatuses in the at least one electronic apparatus to join the group; and
receiving a confirmation message sent by each of the electronic apparatuses in response to the invitation, and accordingly activating the event for the at least one electronic apparatus to participate in.

3. The soft locking method for electronic apparatus as claimed in claim 1, wherein the specific operation detected by each of the at least one electronic apparatus comprises a press operation performed on a physical key, a touch operation performed on a touch screen, an unlocking operation performed under a screen locking state or a trigger operation for a specific application.

4. The soft locking method for electronic apparatus as claimed in claim 1, wherein the step of distributing the suspension message comprises:
distributing the suspension message to all of the at least one electronic apparatus in the group or a social networking website joined by each of the at least one electronic apparatus.

5. The soft locking method for electronic apparatus as claimed in claim 1, wherein after the step of distributing the suspension message or sending the reward to the at least one electronic apparatus participating in the event, the method further comprises:
recording the suspension message and the reward for each of the at least one electronic apparatus to inquire.

6. An electronic apparatus, comprising:
a communication unit, establishing a connection with at least one external electronic apparatus;
a storage unit, recording a plurality of modules;
a processing unit, accessing and executing the modules recorded by the storage unit, wherein the modules comprise:
an event creating module, respectively adding the at least one electronic apparatus to a group, and creating an event for the at least one electronic apparatus to participate in;
a detection module, detecting a specific operation performed on each of the at least one electronic apparatus;
a timing module, accumulating a time that all of the at least one electronic apparatus does not detect the specific operation;
a message distributing module, suspending the event and distributing a suspension message when the detection module detects the specific operation on any of the at least one electronic apparatus; and
a reward generating module, sending a reward to the electronic apparatuses participating in the event when the time accumulated by the timing module reaches a predetermined value.

7. The electronic apparatus as claimed in claim 6, wherein the event creating module launches the group, invites the other electronic apparatuses in the at least one electronic apparatus to join the group, receives a confirmation message sent by each of the electronic apparatuses in response to the invitation, and accordingly activates the event for the at least one electronic apparatus to participate in.

8. The electronic apparatus as claimed in claim 6, wherein the specific operation detected by the detection module comprises a press operation performed on a physical key, a touch operation performed on a touch screen, an unlocking operation performed under a screen locking state or a trigger operation for a specific application.

9. The electronic apparatus as claimed in claim 6, wherein the message distributing module distributes the suspension message to all of the at least one electronic apparatus in the group or a social networking website joined by each of the at least one electronic apparatus.

10. The electronic apparatus as claimed in claim 6, wherein the modules further comprise:
a recording module, recording the suspension message and the reward for each of the at least one electronic apparatus to inquire.
